(19) United States
(12) Patent Application Publication
(10) Pub. No.: US 2016/0334558 A1
(43) Pub. Date: Nov. 17, 2016

(54) A LIGHT CONDUIT FOR AN ILLUMINATION APPARATUS

(71) Applicant: CALSONIC KANSEI UK LIMITED, Dyfed (GB)

(72) Inventor: Gareth Thomas, Dyfed (GB)

(21) Appl. No.: 15/033,378

(22) PCT Filed: Oct. 29, 2014
(86) PCT No.: PCT/GB2014/053219

§ 371 Date: Apr. 29, 2016

(30) Foreign Application Priority Data
Oct. 29, 2013 (GB) 1319042.6

(51) Int. Cl. F21V 8/00; B60Q 3/02; B60Q 3/00

(52) U.S. Cl. CPC G02B 6/001; G02B 6/0006; B60Q 3/004; B60Q 3/0289

(57) ABSTRACT

A light conduit for an illumination apparatus, such as an in-vehicle illumination device, comprises an elongate transparent body (8) having a proximal end and an opposing distal end. The proximal end includes a proximal end face that is configured to permit light from a light source (4) such as an LED to enter and travel longitudinally along the elongate body. The transparent body is configured to permit light to be emitted from the outer surface of the body along its length. The transparent body includes a plurality of three dimensional light distribution features arranged on the surface of the body at the distal end that are configured to increase the amount of light emitted from the body at the proximal end to achieve uniform light transmission along the length of the body.

The present invention relates to a light conduit and in particular a light conduit for a vehicle illumination apparatus.

Lighting is provided within the interior of a vehicle at numerous locations and for a variety of functions. Safety or functional lighting is used to illuminate display panels and highlight vehicle controls. Task lighting is provided to fully or partially illuminate the interior to enable the occupants to perform certain tasks such as reading etc. More recently, lighting is provide within vehicles for aesthetic reasons to provide ambient lighting and/or highlight or emphasise certain interior features of the vehicle, to provide a desirable visual effect.

Known methods for providing ‘aesthetic’ illumination within a vehicle interior include the use of LEDs as a light source and the use of transparent light transmissive elements such as optical fibres or light pipes to direct and emit the light. An LED light pipe may be an optical fibre or a solid transparent plastic rod for transmitting light from an LED to the point of illumination. Light pipes are typically configured to emit light along their length to provide an illuminate path rather than utilising total internal reflection to transmit all of the light to a single end point. It is known to use rigid light pipes to illuminate trim panels within a vehicle. A rigid light pipe is produced with a rigid light transmissive plastic material and can be moulded to the desired form to define a light pathway that may for example correspond to the shape of a vehicle trim panel. Such lighting may be utilised to increase the perceived quality of a vehicle, and it is therefore important that the quality of the light effect is optimised.

In order to produce a desirable light effect it is necessary to maintain a substantially constant intensity of illumination along the light pipe. Due to the dissipation of light energy as the light propagates along the light pipe, the light intensity at the distal end of a light pipe will be significantly diminished compared to the proximal end located nearest the LED light source. This becomes effect is amplifies where the light pipe is curved and the level of light emission increases around the bent sections. As a solution to this problem it is known to provide a pair of LEDs at either end of a trim panel light pipe to with each LED directing light into the pipe from either end. However, this requires two light units and the space to house two light units. As such, this solution increase cost and space requirements for a component that is desirably low cost and able to be easily housed and concealed.

It is therefore desirable to provide an improved illumination device which addresses the above described problems and/or which offers improvements generally.

According to the present invention there is provided a light conduit as described in the accompanying claims.

In an embodiment of the invention there is provided a light conduit for an illumination apparatus comprising an elongate transparent body having a proximal end and an opposing distal end, the proximal end including an proximal end face configured to permit light from a light source to enter and travel longitudinally along the elongate body, the transparent body including about its circumference a longitudinally extending base and a diametrically opposed longitudinally extending light transmitting surface configured to permit light travelling though the body to be emitted from the body along its length via the light emitting surface.

Preferably the transparent body includes a plurality of three dimensional light distribution features arranged on the surface of the body at the distal end configured to increase the amount of light emitted from the body at said proximal end. As light travels along the elongate body, emission through the walls of the body results in the light intensity at the distal end being lower than at the proximal end. The light distribution features assist by boosting the light emission at the distal end, thereby increasing the light intensity to a level approximate to the light intensity at the distal end, thereby obviating the requirement for a second light source at the distal end. The light conduit is preferably configured to receive light from a single end only.

The light distribution surface features are preferably located along a predetermined length of the body, which may be the entire length, and are arranged such that the degree to which the amount of light emitted from the body is increased by the light distribution surface features progressively increases towards the proximal end. This progressive increase in the enhancement of the light emissive properties of the body allows the corresponding progressive diminishment in the intensity of emitted light to be countered by the light distribution features. The light distribution surface features are preferably arranged to progressively increase the amount of light emitted from the body in the direction of the distal end such that overall amount of light emitted from the body is substantially constant along its length.

The light distribution surface features are preferably arranged on the surface in a custom light distribution dot scatter pattern or matrix that is configured to progressively increase the density and/or size of the light distribution surface features toward the distal end. The pattern of the matrix is specifically predetermined to provide a light emission profile that results in constant emission along the length of the body with only a single light source.

The light distribution surface features preferably comprise raised convex projections or dimples extending from the surface of the body. Alternatively, the surface features may be any three dimensional features that disperse light from within the body to a greater extent that the standard outer surface of the body.

The body preferably comprises an upper surface which in use is arranged to define the primary light emitting surface, lower surface and opposing side walls and the light distribution surface features are arranged along at least a portion of the upper surface, such that the light is at least enhanced along the primary illumination surface.

The upper surface is preferably convex in shape in the transverse direction to optimise light emission from the primary surface.

The body preferably includes integrally moulded attachment features for engagement with corresponding fixings to secure the body to a further surface. Preferably the attachment features include one or more sections of the lower portion of the body that extend outwardly of the side walls defining a projections that are preferably one or more flanged attachment features for securing the body to a support surface. The attachment projections may extend from one or both sides of the body along in a lengthwise direction. This enables the light pipe to be easily secured to a support surface having simple clips that grip the flange section, rather than requiring a more complex clipping arrangement, and enables the light pipe to be secured by its base rather than requiring a fixing that extends over the upper surface of the body thereby obscuring the light emitting surface. The one or more attachment features preferably include an upper fixing surface facing away from the base of the body and which in use faces away from the surface to which the body is secured, providing a surface against which a fixing may clamp to secure the body to said surface.

At least the upper surface may include a transparent surface coating having a hardness greater than the material of the body to protect the body from damage in use. This enables the light pipe to be located at the A surface of a vehicle to produce a desirable visual effect.

The body is preferably formed from a transparent polymer which enable it to be moulded to any desired longitudinal path shape to correspond to the illumination path required.

The light distribution features are preferably integrally moulded with the body.

The body preferably narrows towards the light emitting surface. Preferably the body includes a main light transmitting portion arranged towards its base and a light transmitting

In another aspect of the invention there is provided an illumination apparatus comprising a light conduit as described above; and a light source arranged to direct light into the proximal end face of the light conduit.

The light source preferably comprises an opaque housing and a light emitting element located within the housing, the housing being secured to the proximal end of the body such that the light emitting element is arranged proximate the end face of the conduit.

The light emitting element is a preferably a light emitting diode (LED).

A light source is preferably located only at the proximal end of the conduit.

In another aspect of the invention a method of manufacturing a light conduit comprising moulding an elongate body from transparent material having a proximal end and an opposing distal end, the proximal end including an proximal end face configured to permit light from a light source to enter and travel longitudinally along the elongate body with the transparent body being configured to permit light to be emitted from the outer surface of the body along its length, and integrally moulding as part of the body a plurality of three dimensional light distribution features arranged on the surface of the body at the distal end configured to increase the amount of light emitted from the body at said proximal end.

The light distribution features preferably comprise a plurality of raised projections arranged in a matrix on the surface of the body and the method comprises forming a matrix of recesses in the mould surface corresponding to the matrix of projections.

The matrix is preferably configured to progressively increase the density and/or size of the light distribution surface features toward the distal end to progressively increase the amount of light emitted from the body in the direction of the distal end such that overall amount of light emitted from the body is substantially constant along its length.

The matrix is preferably configured using software to determine the required light emission profile and generate a corresponding matrix which is then formed on the surface of the mould by laser etching.

The present invention will now be described by way of example only with reference to the following illustrative figures in which:

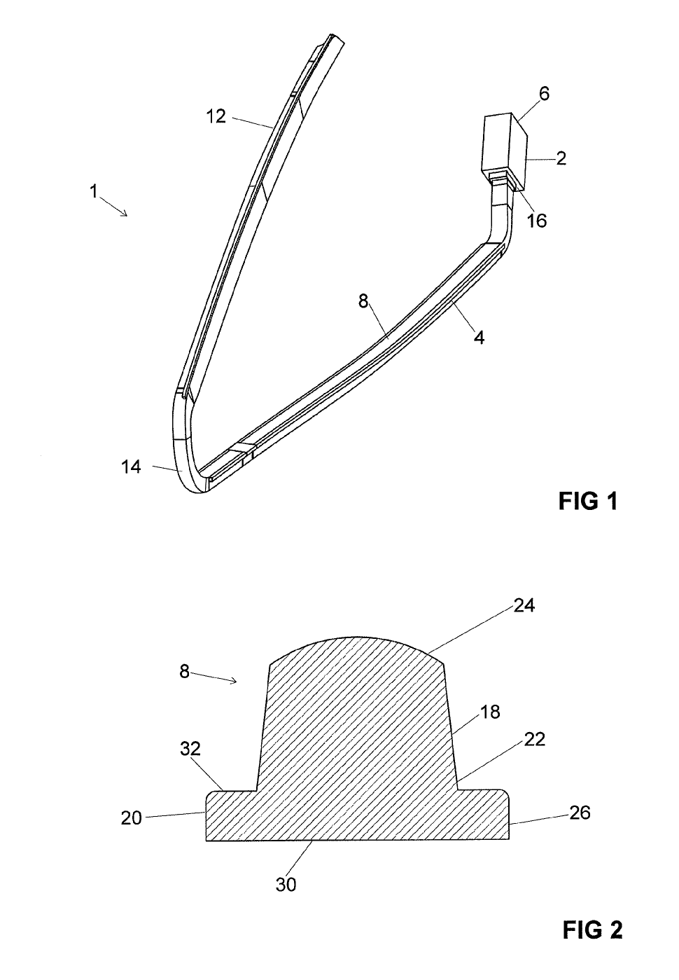

FIG. 1 shows a light conduit according to an embodiment of the invention;

FIG. 2 shows a cross sectional view of a light pipe according to an embodiment of the invention;

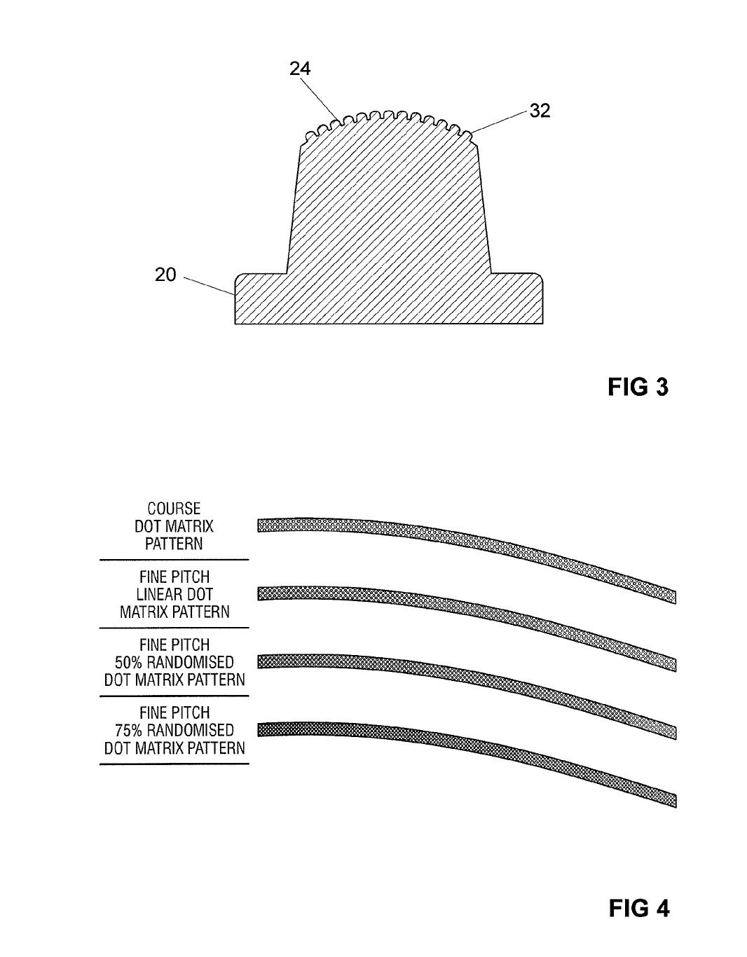

FIG. 3 shows the arrangement of FIG. 2 with the light distribution features enlarged for illustrative effect;

FIG. 4 shows a set of graduated light distribution matrix patterns according to an embodiment of the invention;

FIG. 5 shows a light conduit clipped to a support surface according to an embodiment of the invention; and

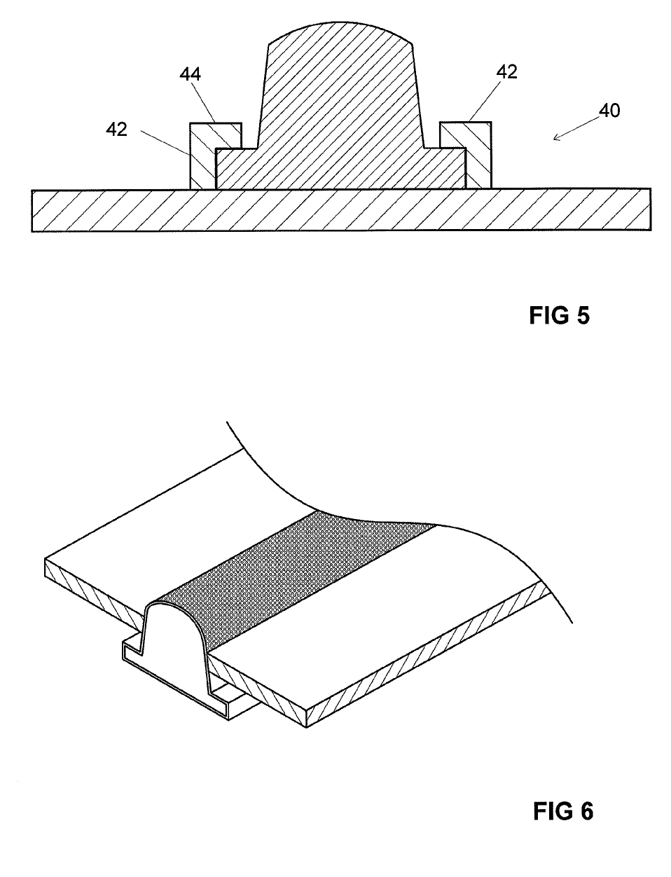

FIG. 6 shows a light conduit located within the A-surface of a vehicle trim panel.

Referring to FIG. 1, an illumination element 1 comprises and an illumination source 2 and a light emitting element 4. The illumination source 2 includes a light emitting diode (LED) housed within an enclosure 6. The enclosure 6 is located at a first end of the light emitting element 4. The light emitting element 4 comprises an elongate body 8 formed of a transparent light transmissive material. Preferably the body 8 is formed from a transparent light transmissive optical polymer material.

The body 8 is shaped along its length to correspond to a required illumination path. In the arrangement shown in FIG. 1 the body 8 is shaped to follow the peripheral edge of a vehicle trim panel to provide hidden illumination from behind said panel, and includes first and second elongate sections 10 and 12 interconnected by a bend section 14. However it will be appreciated that the shape of the body 8 could be modified do define any suitable illumination path.

The light source 2 is located at the proximal end 16 of the body 8. The proximal end 16 of the body 8 preferably includes a planar end face that is arranged transverse to the longitudinal axis of the body 8. The housing 6 of the light source 2 is connected to the distal end 16 such that the LED is arranged proximate the distal end face to direct light into the body 8 via the end face. The housing 6 defines a light shield to maximise the light from the LED that is transmitted into the body 8.

As shown in the cross sectional view of FIG. 2, the body 8 of the light element 4 includes a main body section 18 and a base section 20. The base section 20 and main body section 18 are integrally formed and define different zones of the body 8 when taken in cross section. The main body section 18 includes side walls 22 and a convex curved upper surface 24. The side walls 22 taper inwardly towards the curved upper surface. This unique cross sectional shape of the light pipe 2 allows the light to be evenly distributed around a bend without a loss in intensity, with the wider lower portion optimising the flow of light through the pipe 2, and then the narrowing upper portion acting to focus the light to the top surface 24, to optimising the light emission from the upper surface 24, and at the same time limiting the same emission through the side walls 22. As such, the upper surface 24 is able to be maintained in a constant plane that optimises the consistency of the output from the upper surface 24, while the side walls are bent to define the required geometry. In addition, narrowing the main body section 18 from the base towards the light emitting surface 24 provides a focussing effect in which the larger portion of the body towards the base maximises the light that may be carried by the body 18, with the light being focused to a narrow portion at the upper surface 24 for emission. The narrower light emitting surface may be exposed through the surface of the trim panel or other surface providing a narrow yet bright strip light at the surface.

The base section 20 extends outwardly of the main body section 18 on both sides of the main body section 18 to define flanges which form fixing feet 26. The flange section 26 extends along the length of the body 8 defining a pair of opposed fixing rails at the base of the main body section 18. The flange 26 may extend continuously or may include intermittent spacings along sections that do not require fixings. Alternatively the fixings may include one or more discrete projections or other attachment formations that are integrally moulded with the light pipe 2 and enable the attachment of fixings secured to a surface to which the light pipe 2 is to be affixed. The base 18 further includes a planar lower surface 16 arranged perpendicular to the side walls 22 of the body section 8, side walls 28 defining the outer edges of the fixing rails 26 arranged perpendicular to the lower surface and parallel to the side walls 8 of the body section 4, and upper fixing surfaces 32 arranged substantially parallel to the lower surface 30 or sloping inwardly and downwardly towards the main body 18. It will be appreciated that the features of the attachment elements described above each provide advantages and it is conceived that each may be implemented in various embodiments without limitation to their combination with any of the additional features described above.

Light directed into the illuminating body 2 via the proximal end face travels longitudinally along the body 8 and is retained within the body during travel due to internal reflection. As the light internally reflects along the length of the body 8, at each point of reflection a certain proportion of the light is emitted from the body 8 and a further proportion of the light is reflected internally back into the body 8. Internal reflection within the body depends on the incident angle of the light at the surface of the body 8. The light emitting from causes the body 8 to glow along its length.

As light travels along the length of the body 8 of the illumination element 4 the intensity of the emitted light dissipates and diminishes due to the external emission of the light. It is desirable for the light intensity to appear substantially constant along the length of the body 8. Therefore, a plurality of light emitting features are provided along the length of the body 2 to increase the light emitted from within body along its length to counteract the diminishing intensity of the light in the longitudinal direction.

As shown in FIG. 3, the light emitting features preferably comprise a plurality of convex projections or dimples 32 arranged on the surface of the light emitting body 8. In FIG. 3 the size of the surface projections are enlarged for illustrative purposes. The convex projections 32 are integrally formed with the body and are preferably formed during moulding of the body. The convex projections 32 alter the surface configuration and hence the incident angle of the light at the location of each projection. As a result there is in an increase in the amount of light emitted from the body 8 at these locations. The projections 32 are provided along the upper surface 24 of the light emitting element 4, and in the arrangement of FIG. 3 are also provided along the lower surface 30. Projections 32 may also be provided along the side walls 22.

The projections may be located along the body 8 of the light emitting element 4 towards the distal end to increase the emittance of light at the distal end as the intensity of light transmitted within the body 8 decreases. It is preferred that the intensity of light remains constant along the length of the body. Therefore, rather than a step change in intensity being created by providing the projections 32 only in one location at the proximal end of the body 8, the projections are introduced along the length of the body in a progressive and graduated manner. In one embodiment this may be achieved by providing the projections in a matrix formation comprising a pattern of projections 32 that is extended along the length of the body 8.

The pattern is repeating and is selected to provide the projections 32 at set spacings and relative positions. The matrix arrangement is varied along the length of the body 8, preferably using the same or similar pattern along the length, but varying the density of the pattern and/or the size of the projections 32. The graduated matrix is arranged such that the density of projections 32 increases along the length of the body 8 towards the distal end, along the section of the body on which the projections are provided. A set of example matrix patterns are shown in FIG. 4. The graduated matrix pattern may be selected and correlated to the linear decrease in light intensity along the body 8 of the light emitting element 4 to ensure a consistent emitted light intensity along the entire length of the body 8. The light emission signature of the matrix pattern may be altered by varying the size of the projections 32 and/or the pitch of the graduated pattern and/or the matrix pattern itself.

The projections 32 are preferably formed by laser etching corresponding concave formations into the mould surface. The use of laser etching allows the graduated matrix pattern to be designed and precisely specified using computer aided design software, and for the generated design to then be precisely translated to the mould surface using the a computer controlled laser etching apparatus.

As shown in FIG. 5, the flanged base section 26 provides a quick, secure and convenient means of securing the illumination element 4 to a support surface 36. A plurality of fixing clips 40 are provided at spaced intervals along the length of the body 8. The fixing clips 40 are secured to the support surface 36 by any suitable means. The fixing clips include in a pair of arms 42 that extend substantially perpendicularly from the surface 36 and include upper inwardly extending retaining sections 44 that extending inwardly towards each other. The retaining sections 44 are arranged at a height corresponding to the depth of the flange sections 26. In use the flanged base section 26 is introduced into the clip 40 such the feet defined by the flanged sections 26 are received within the clips 40, which are preferably flexible to enable the feet 26 to be inserted. When received within the clips 40 the feet 26 are vertically and transversely retained. As the flanged section 26 extends continuously along the length of the body 8 the clips 40 may conveniently be located at any point along the length of the body 8 to ensure a secure connection to the support surface 36.

The light emitting element 8 is intended to be located behind and secured by a trim panel or other suitable element such that only the emitted light and not the illumination member 4 itself is visible. In a further embodiment, as shown in FIG. 6, the illumination element may be located within a channel formed in an interior trim surface, such that at least part of the body 8 is visible in use. In the arrangement of FIG. 6 the upper surface 24 of the body 8 is arrangement within a channel of a trim panel 46 such that it forms part of the ‘A’ surface, which is the surface that is immediately contactable by an occupant of the vehicle. Typically optical surfaces are not provided at the A surface as contact by the occupants causes surface damage and degradation of the appearance and optical properties of the component. However, a desirable visual effect may be achieved by locating an illumination at the A surface level.

Therefore, in one embodiment the body 8 is coated with a transparent coating that has a hardness greater than the hardness of the polymer of the body 8. The coating is preferably applied to the entire body 8 after the body 8 has been moulded. Alternatively the coating is applied at least to the surface of the body 8 that will form part of the A surface and will be visible in use. The coating protects the outer surface from damage such a scratching from contact. The hardcoat is preferably a clear varnish coating that is applied by a dipping process in which the clear lightpipe 2 is fitted to a jig and then the jig assembled to a dip tank that slowly lowers the lightpipe 2 into the clear coating liquid. The hardcoat preferably coats the entire outer surface of the lightpipe 2 and after a curing process via an oven forms a solid outer layer that is keyed to the surface of the lightpipe 2. In this way, the part of the lightpipe 2 that is exposed at the A surface is protected from cosmetic damage.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A light conduit for an illumination apparatus comprising an elongate transparent body having a proximal end and an opposing distal end, the proximal end including an proximal end face configured to permit light from a light source to enter and travel longitudinally along the elongate body, the transparent body including about its circumference a longitudinally extending base and a diametrically opposed longitudinally extending light transmitting surface configured to permit light travelling though the body to be emitted from the body along its length via the light emitting surface.

2. A light conduit according to claim 1 wherein the transparent body includes a plurality of three dimensional light distribution features arranged on the light emitting surface of the body at the distal end configured to increase the amount of light emitted from the body at said proximal end.

3. A light conduit according to claim 2 wherein the light distribution surface features are located along a predetermined length of the body and are arranged such the degree to which the amount of light emitted from the body is increased by the light distribution surface features progressively increases towards the proximal end.

4. A light conduit according to claim 3 wherein the light distribution surface features are arranged to progressively increase the amount of light emitted from the body in the direction of the distal end such that overall amount of light emitted from the body is substantially constant along its length.

5. A light conduit according to claim 4 wherein the light distribution surface features are arranged on the surface in a matrix that is configured to progressively increase the density and/or size of the light distribution surface features toward the distal end.

6. A light conduit according to claim 2 wherein the light distribution surface features comprise raised convex projections extending from the surface of the body.

7. A light conduit according to claim 1 wherein the body comprises an upper surface which in use is defines the primary light emitting surface, lower surface which defines the base and opposing side walls and the light distribution surface features are arranged along at least a portion of the upper light emitting surface.

8. A light conduit according to claim 7 wherein the upper light emitting surface is convex in shape in the transverse direction.

9. A light conduit according to clam 1 wherein the body includes at least one integrally formed projection extending outwardly of eth body defining an attachment feature for securing the body to a support surface.

10. A light conduit according to claim 9 wherein the at least one attachment feature comprises a flanged longitudinally extending projecting laterally outwards of the side wall of the body.

11. A light conduit according to claim 10 comprising longitudinally extending laterally projecting attachment features located on either side of the body proximate the base.

12. A light conduit according to claim 1 wherein at least the light emitting surface includes a transparent surface coating having a hardness greater than the material of the body to protect the body from damage in use.

13. A light conduit according to claim 1 wherein the body is formed from a transparent polymer.

14. An illumination apparatus comprising:
a light conduit according to claim 1; and
a light source secured to the conduit and arranged to direct light into the proximal end face of the light conduit.

15. An illumination apparatus according to claim 14 wherein the light source comprises an opaque housing and a light emitting element located within the housing, the housing being secured to the proximal end of the body such that the light emitting element is arranged proximate the end face of the conduit.

16. An illumination apparatus according to claim 15 wherein the light emitting element is a light emitting diode.

17. An illumination apparatus according to claim 14 wherein a light source is located only at the proximal end of the conduit.

18. A method of manufacturing a light conduit comprising moulding an elongate body from transparent material having a proximal end and an opposing distal end, the proximal end including an proximal end face configured to permit light from a light source to enter and travel longitudinally along the elongate body with the transparent body being configured to permit light to be emitted from the outer surface of the body along its length, and integrally moulding as part of the body a plurality of three dimensional light distribution features arranged on the surface of the body at the distal end configured to increase the amount of light emitted from the body at said proximal end.

19. A method according to claim 18 wherein the light distribution features comprises a plurality of raised projections arranged in a matrix on the surface of the body and the method comprises forming a matrix of recesses in the mould surface corresponding to the matrix of projections.

20. A method according to claim 20 wherein the matrix is configured to progressively increase the density and/or size of the light distribution surface features toward the distal end to progressively increase the amount of light emitted from the body in the direction of the distal end such that overall amount of light emitted from the body is substantially constant along its length.

21. A method according to claim 20 wherein the matrix is configured using software to determine the required light emission profile and generate a corresponding matrix which is then formed on the surface of the mould by laser etching.
